(19) United States
(12) Patent Application Publication
(10) Pub. No.: US 2010/0283889 A1
(43) Pub. Date: Nov. 11, 2010

(54) MEDIA DISPLAY APPARATUS

(76) Inventor: Brian M. Johnson, Delaware, OH (US)

Correspondence Address: QUICKPATENTS, INC., 32861 CALLE PERFECTO, SUITE A, SAN JUAN CAPISTRANO, CA, 92675, US

(21) Appl. No.: 12/771,145

(22) Filed: Apr. 30, 2010

Related U.S. Application Data
(60) Provisional application No. 61/176,607, filed on May 8, 2009.

(51) Int. Cl. H04N 5/64; H04N 5/225; B62D 9/00

(52) U.S. Cl. 348/370; 348/838; 348/789; 348/372; 180/400; 348/E07.085; 348/E05.132

(57) ABSTRACT

A mobile system that is capable of providing advertising both indoors or outside is provided. The system may be remotely controlled by a user. Using the remote control the user is capable of changing the height of the advertisement display, on demand, for example, depending on the location and desired height that a user would like to display an advertisement.

### CROSS-REFERENCE TO RELATED APPLICATIONS

This application claims the benefit of U.S. Provisional Patent Application 61/176,607, filed on May 3, 2009, and incorporated herein by reference.

### STATEMENT REGARDING FEDERALLY SPONSORED RESEARCH AND DEVELOPMENT

Not applicable.

### FIELD OF THE INVENTION

The present invention generally relates to advertisement displays and, more specifically, to a mobile, remote-controlled, electronic advertisement display device.

### DISCUSSION OF RELATED ART

The success of traditional fixed billboard and wall-type advertising depends on the location and placement of the advertisement. To be effective, advertisers must choose what they feel is the best ad location that they can afford in the hopes that potential consumers will see and react to the message in the advertisement. One problem with traditional fixed billboard and wall-type advertising is the mobility of the advertisement. These types of fixed location advertising devices are not mobile and cannot move with or to a target audience on demand. Another problem with fixed location outdoor advertising such as billboards and banners is that this type of advertising is prohibited in many places.

Another type of advertising method includes mobile vehicle advertising such as banners or video ads on automobiles. The type of advertising faces the problem of restricted access to an intended audience. Mobile vehicle advertisers are limited to advertising only from roads and parking areas. Mobile vehicle advertisers are not able to drive their vehicles around inside a public retail structure or on public sidewalks to capture the attention of their intended audiences.

One such advertisement system that attempts to solve the above disadvantages mentioned above is U.S. Patent Application Publication No. US 2004/0049960 A1 to Percy, on Mar. 18, 2004. Percy describes an advertisement system that allows display of at least one product advertisement. The system includes a base, an advertisement display unit, a motor, and a receiver. The receiver receives input signals from a control unit that is remotely located, and converts the input signals into control signals that control operation of the motor and advertisement display unit. A power source can be mounted on the base to supply power to the system. However, the advertisement system of Percy is for the inside of a store only, and is not capable of surviving the weather elements outside, such as rain, sleet, or snow. In addition, the system of Percy does not provide a mechanism for adjusting the height of the display of the system.

Therefore, there is a need for an apparatus that is capable of providing advertising both indoors or outside. Also, there is a need for an apparatus that can be remotely controlled by a user and that is capable of changing locations and heights, on demand, for example, depending on the location and desired height that a user would like to display an advertisement. The present invention accomplishes these objectives.

### SUMMARY OF THE INVENTION

The present device is a media display platform for displaying media content such as advertisements, warnings, and other content. The platform includes a chassis, at least three wheels adapted to moveably support the chassis on a ground surface, a motive mechanism fixed with the chassis and adapted for driving at least one of the wheels in a rotational motion, a controller in electronic communication with the motive mechanism and adapted to control a speed and a direction that the motive mechanism drives the at least one of the wheels, at least one display screen fixed with the chassis, a media player in electronic communication with the at least one display screen and adapted for playing the media thereon, a power source electrically connected with at least the motive mechanism and each display screen, and a lift mechanism fixed with the chassis and each display screen, electrically connected with the power source and the controller, and adapted to lift at least one of the display screens above the chassis.

The controller may be used to direct the chassis to move along the ground surface while the media player plays a video portion of the media on the at least one display screen. The controller may be a wireless remote control that gives a user the option of changing the direction, speed, height, and the like, of the at least one display. In some embodiments, the platform may be completely automatic with no need for user control.

In some embodiments, the platform may include at least one speaker electronically connected with the media player, such that an audio portion of the media may be reproduced thereby. In some embodiments, the platform may further include a radio transmitter for broadcasting an audio portion of the media.

The present system is capable of providing advertising anytime, anywhere, be it indoors or outside. Also, the present system may be remotely controlled by a user. Using the remote control the user is capable of changing the height of the advertisement display, on demand, for example, depending on the location and desired height that a user would like to display an advertisement. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1A is an example of a media display apparatus that is displaying an advertisement on a surface, according to various embodiments;

FIG. 1B is an example of the media display apparatus illustrated in FIG. 1A, according to various embodiments;

FIG. 2 is an exploded view of an example media display apparatus, according to various embodiments;

FIG. 3 is a side-perspective of an example media display apparatus, according to various embodiments;

FIG. 4 is an internal view of an example media display apparatus, according to various embodiments; and

FIG. 5 is a side-perspective of an example media display apparatus, according to various embodiments.

### DETAILED DESCRIPTION OF THE PREFERRED EMBODIMENT

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

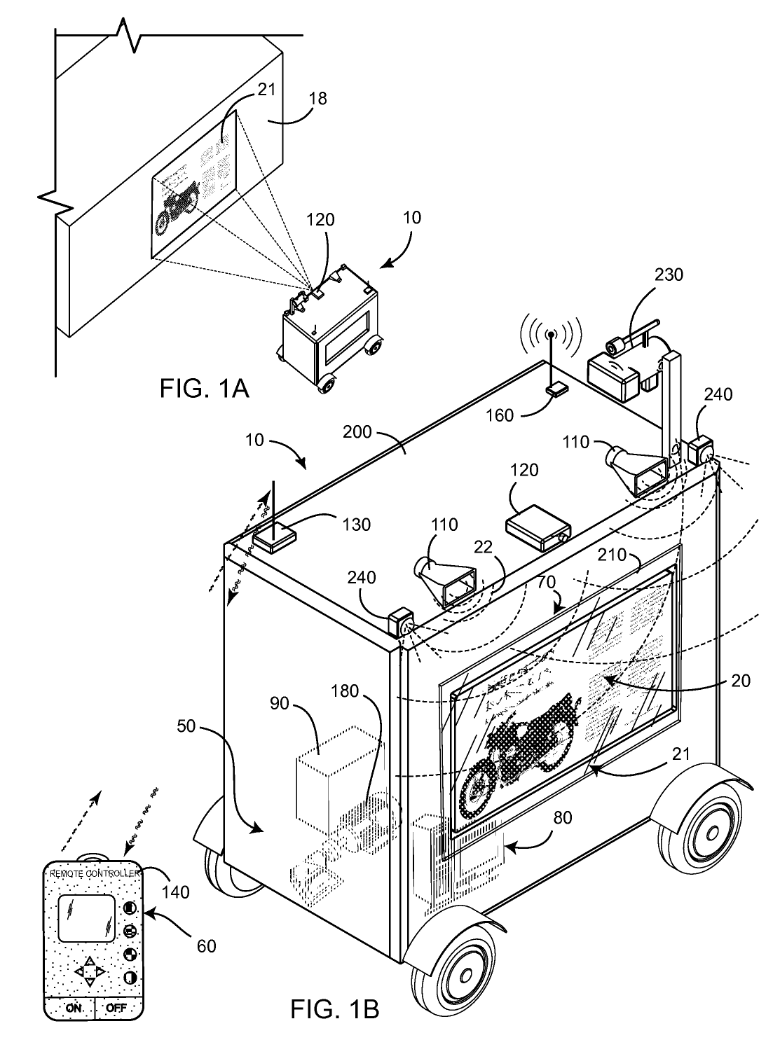

FIG. 1A illustrates an example of a media display apparatus that is displaying an advertisement on a surface. Referring to FIG. 1A, a media display apparatus platform 10 (hereinafter platform 10) displays media content, such as video 21, onto a surface 18.

FIG. 1B illustrates an example of the media display apparatus illustrated in FIG. 1A. FIG. 4 illustrates an internal view of an example media display apparatus. Referring to FIGS. 1B and 4, platform 10 displays media 20. The platform 10 includes a chassis 30 that is disposed on an underside of platform 10, and which supports the body of platform 10. The size of the chassis may 30 vary depending on the size of the body of platform 10. The chassis may be comprised of various materials, for example, wood, plastic, metal, and the like. The metal may include, for example, aluminum, steel, carbon fiber, and the like.

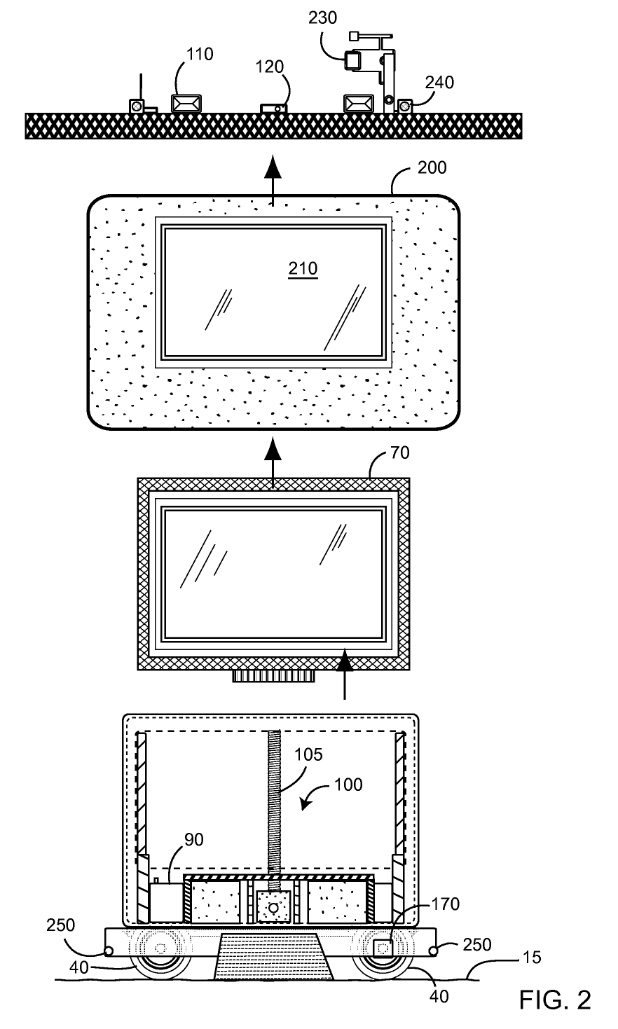

The platform 10 includes at least three wheels 40 that are adapted to moveably support the chassis 30 on a ground surface 15 (shown in FIG. 2). The number of wheels 40 may vary, for example, the number of wheels 40 may be 3 wheels, 4 wheels, 5 wheels, 6 wheels, or more wheels. The size and material of the wheels 40 may vary as desired. The wheels 40 may be constructed from any desired material, for example, the wheels 40 may be comprised of rubber, plastic, metal, and the like.

The platform 10 includes a motive mechanism 50 fixed with the chassis 30 and adapted for driving at least one of the wheels 40 in a rotational motion. For example, the motive mechanism 50 may include an electric motor. The motive mechanism 50 may provide the forward and reverse power or drive movement to the wheels 40 to propel the platform 10 forward and backward. The motive mechanism 50 may also provide the platform with a propulsion stop function. The motive mechanism 50 may include various safety features. For example, when the forward and/or reverse function of the motive mechanism 50 is not engaged, the motive mechanism 50 may instantly eliminate power, thus locking the wheels 40 in place. This locking may stop any and all forward or reverse wheel 40 movement, even on an incline or decline. This motor locking feature provides safety to the media display apparatus and the people around.

In some embodiments, the motive mechanism 50 includes at least a gas-powered engine (not shown) mechanically coupled to at least one of the wheels 40. In some embodiments, the platform 10 may further include at least one proximity sensor 250 for overriding commands to the motive mechanism 50 when a hazard is detected thereby. For example, when a person is sensed near or approaching the platform 10, the at least one proximity sensor 250, may sense the movement, and thereby detect a hazard. The at least one proximity sensor 250 may override the commands to the motive mechanism 50 to shut down the power, or to stop the platform 10 from moving.

The platform 10 includes a controller 60 in electronic communication with the motive mechanism 50 and adapted to control the motive mechanism including the speed and direction that the motive mechanism 50 drives at least one wheel 40. The controller 60 may include a wireless transmitter 140 that allows a user to remotely control the platform 10. For example, the controller 60 may include a radio controller 140 that receives signal inputs from joysticks, switches, buttons, and the like, of the controller 60, and transmits the signals to a radio receiver 130 that is in electrical communication with the motive mechanism 50. The radio receiver 130 may read the transmitted signals and translate them into actions for controlling direction and propulsion of the platform 10.

The platform 10 includes at least one display screen 70 fixed with the chassis 30. The display may be comprised of, for example, light emitting diodes (LEDs), organic LEDs (OLEDs), liquid crystal design (LCD), plasma screen, and the like. The size of the display screen 70 may vary. For example, the display screen 70 may include a 19 inch screen, a 27 inch screen, a 35 inch screen, a 48 inch screen, a 60 inch screen, or other desired size. The at least one display screen 70 may include a plurality of displays, for example, two displays, three displays, four displays, and the like. The display screen 70 may include a monitor mount to stably hold the display screen 70 in place inside the platform 10. The controller 60 may also control the movement, on/off, direction, and the like, of the at least one display screen 70.

The platform 10 includes a media player 80 in electronic communication with the at least one display screen 70 and adapted for playing the media thereon. The media player 80 may be a media player integrated into the at least one display 70. The media player 80 may be a stand-alone media player such as a computer hard drive. The media player 80 may provide video and/or audio playback functions from data stored on the hard drive. The data may include, for example, motion images, audio recordings, digital images, and the like. In some embodiments, the controller may include a receiver 130 and a wireless transmitter 140. The wireless transmitter 140 may be adapted to transmit commands 150 to the receiver 130 for controlling the motive mechanism 50 and the media player 80.

In some embodiments, the platform 10 may further include at least one speaker 110 electronically connected with the media player 80, such that an audio portion 22 of the media may be reproduced thereby. In addition, the speaker 110 may produce alerts such as beeps and alarms to indicate to pedestrians that the platform 10 is approaching. In some embodiments, the platform 10 may further include a radio transmitter 160 for broadcasting the audio portion 22 of the media.

The platform 10 includes a power source 90 electrically connected with at least the motive mechanism 50 and each display screen 70. The power source 90 may be a rechargeable power supply, for example, a rechargeable 12-volt battery, and the like. The platform 10 may include an on-board battery charger that may replenish/recharge the power source 90. The power source 90 may consist of a plurality of batteries, for example, two batteries, three batteries, four batteries, or more. Each of the batteries may have any desired and appropriate voltage and capacity. The platform 10 may include a power inverter to convert battery power to AC 110V power for powering electrical devices such as DVD players, or the like. Further, the platform 10 may receive power from an external source, such as from an outlet, via one or more extension cables (not shown). In some embodiments, the motive mechanism 50 includes at least an electric motor 180 electrically connected with the power source 90 and the controller 60.

FIG. 2 illustrates an exploded view of an example media display apparatus. Referring to FIGS. 1B and 2, the platform 10 includes a lift mechanism 100 fixed with the chassis 30 and each display screen 70, electrically connected with the power source 90 and the controller 60, and adapted to lift at least one of the display screens 70 above the chassis 30. The lift mechanism 100 may include a motor that is in electrical communication with the controller 60, and which is capable of mechanically moving the lift mechanism 100 up and down. Using the controller 60, a user may remotely control the movement of the lift mechanism 100. Also, a power inverter may be electrically connected to a power strip that is electrically connected to one or more of the motive mechanism 50, the at least one display, 70, the media player 80, and the lift mechanism 100.

Accordingly, the controller 60 may be used to direct the chassis 30 to move along the ground surface 15 while the media player plays a video portion 21 of the media on the at least one display screen 70. In some embodiments, the platform 10 may further include a digital projector 120 interconnected with the power source 90 and the media player 80, such that the video portion of the media may be projected onto a surface 18 thereby.

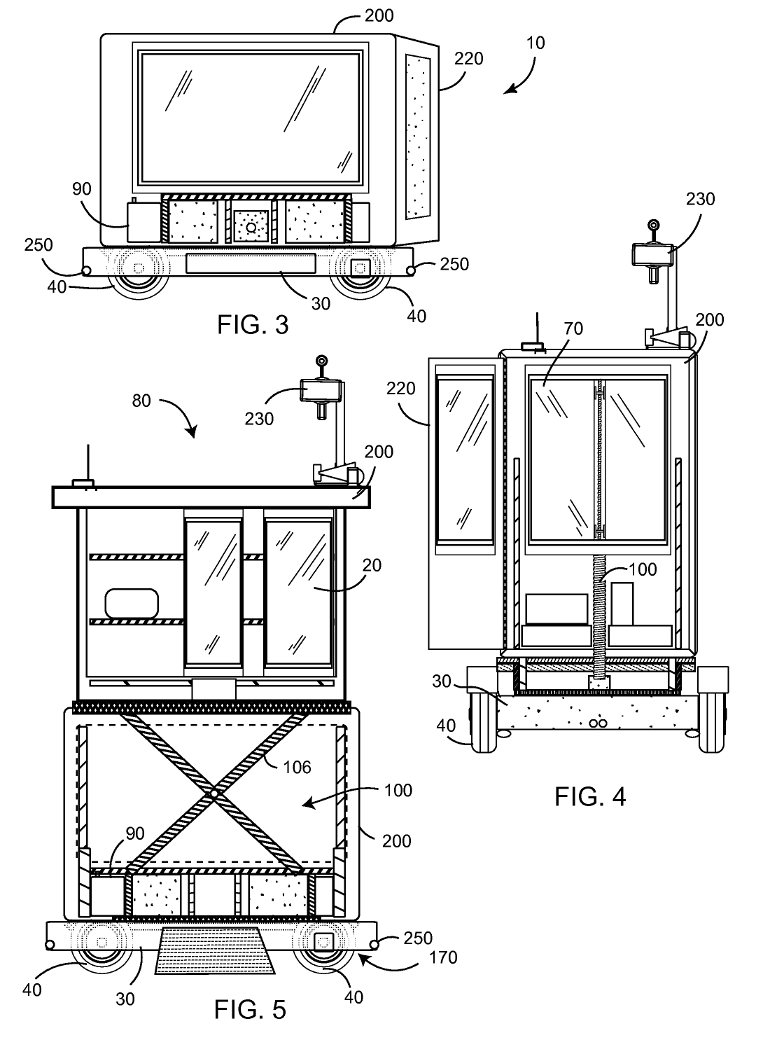

FIG. 3 illustrates a side-perspective of an example media display apparatus. Referring to FIGS. 1B, 3, and 4, in some embodiments, the platform 10 may further include a weatherproof enclosure 200. The enclosure 200 may include at least one transparent portion 210 approximately aligned with each display screen 80, such that water impacting the platform 10 does not gain access to the at least one display screen 80. In addition, the controller 60, the power source 90, and/or the media player 80 may be included in the enclosure 200. The enclosure 200 may further include at least one openable access panel 220.

In some embodiments, the platform 10 may further include at least one camera 230 fixed with the chassis 30 and electrically connected with the power source 90, the controller 60, the media player 80, and/or at least one electronic memory. The camera may be used to take digital images. In some embodiments, the platform may further include at least one light source 240 electrically connected with the power source 90 and the controller 60. Each light source 240 may be adapted for illuminating an area around the platform 10 when the camera 230 is activated by the controller 60.

FIG. 5 illustrates a rear-perspective of an example media display apparatus. Referring to FIGS. 1B and 5, in some embodiments, at least one of the wheels 40 may be mechanically coupled to a steering mechanism 170 that is electronically connected with the controller 60 and the power source 90. Also, the controller 60 may be adapted to issue steering commands to the steering mechanism 170 such that the platform 10 may be steered thereby. In some embodiments, the platform 10 may further include at least one stabilizing brace 260 (shown in FIG. 5) fixed with the chassis 30 and adapted to be positioned onto the ground surface 15 to maintain the chassis 30 in an upright configuration.

While a particular form of the invention has been illustrated and described, it will be apparent that various modifications can be made without departing from the spirit and scope of the invention. For example, in some embodiments, the platform 10 is not controlled by a user but is instead fully automatic and programmed to function as an intelligent robotic system. For example, a computer and/or one or more sensors may drive and guide the platform 10. In some embodiments, the platform 10 may be used with tank tracks to provide skid steering and/or differential steering. Accordingly, it is not intended that the invention be limited, except as by the appended claims.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

What is claimed is:

1. A platform for displaying media, comprising:
a chassis;
at least three wheels adapted to moveably support the chassis on a ground surface;
a motive mechanism fixed with the chassis and adapted for driving at least one of the wheels in a rotational motion;
a controller in electronic communication with the motive mechanism and adapted to control a speed and a direction that the motive mechanism drives the at least one of the wheels;
at least one display screen fixed with the chassis;
a media player in electronic communication with the at least one display screen and adapted for playing the media thereon;
a power source electrically connected with at least the motive mechanism and each display screen; and
a lift mechanism fixed with the chassis and each display screen, electrically connected with the power source and the controller, and adapted to lift at least one of the display screens above the chassis;
whereby the controller may be used to direct the chassis to move along the ground surface while the media player plays a video portion of the media on the at least one display screen.

2. The platform of claim 1 further including at least one speaker electronically connected with the media player, such that an audio portion of the media may be reproduced thereby.

3. The platform of claim 1 further including a digital projector interconnected with the power source and the media player, such that a video portion of the media may be projected onto a surface thereby.

4. The platform of claim 1 wherein the controller includes a receiver and a wireless transmitter, the wireless transmitter adapted to transmit commands to the receiver for controlling the motive mechanism and the media player.

5. The platform of claim 1 further including a radio transmitter for broadcasting an audio portion of the media.

6. The platform of claim 1 wherein at least one of the wheels is mechanically coupled to a steering mechanism that is electronically connected with the controller and the power source, the controller adapted to issue steering commands to the steering mechanism such that the platform may be steered thereby.

7. The platform of claim 1 wherein the motive mechanism includes at least an electric motor electrically connected with the power source and the controller.

8. The platform of claim 1 wherein the motive mechanism includes at least a gas-powered engine mechanically coupled to at least one of the wheels.

9. The platform of claim 1 further including a weatherproof enclosure, the enclosure including one transparent portion aligned with each display screen, such that water impacting the platform does not gain access to the at least one display screen, the controller, the power source, and the media player, the enclosure further including at least one openable access panel.

10. The platform of claim 1 further including at least one camera fixed with the chassis and electrically connected with the power source, the controller, and at least one electronic memory.

11. The platform of claim 10 further including at least one light source electrically connected with the power source and the controller, each light source adapted for illuminating an area around the platform when the camera is activated by the controller.

12. The platform of claim 1 further including at least one proximity sensor for overriding commands to the motive mechanism when a hazard is detected thereby.

13. The platform of claim 1 further including at least one stabilizing brace fixed with the chassis and adapted to be positioned onto the ground surface to maintain the chassis in an upright configuration.
